(19) United States
(12) Patent Application Publication
(10) Pub. No.: US 2013/0307973 A1
(43) Pub. Date: Nov. 21, 2013

(54) MULTIFUNCTIONAL TELEVISION

(71) Applicant: HON HAI PRECISION INDUSTRY CO., LTD., New Taipei (TW)

(72) Inventor: TIEN-YU LIN, New Taipei (TW)

(73) Assignee: HON HAI PRECISION INDUSTRY CO., LTD., New Taipei (TW)

(21) Appl. No.: 13/873,242

(22) Filed: Apr. 30, 2013

(30) Foreign Application Priority Data
May 21, 2012 (TW) 101117960

(51) Int. Cl. H04N 7/18

(52) U.S. Cl. CPC H04N 7/18
USPC 348/143

(57) ABSTRACT

A multifunctional television includes a television mode and a monitoring mode. The multifunctional television includes a television module for broadcasting television shows in the television mode, a monitoring module for monitoring in the monitoring mode and a switching module for switching the multifunctional television between the television mode and the monitoring mode. The monitoring module includes an image analysis unit, an identifying unit and an alarm unit. The image analysis unit is used for capturing images surrounding the multifunctional television and compares a current image with a previous image to determine whether the current image and the previous image are different. The identifying unit is used for determining whether there is a suspicious character when the images are different. The alarm unit is used for sending a warning signal if there is a suspicious character.

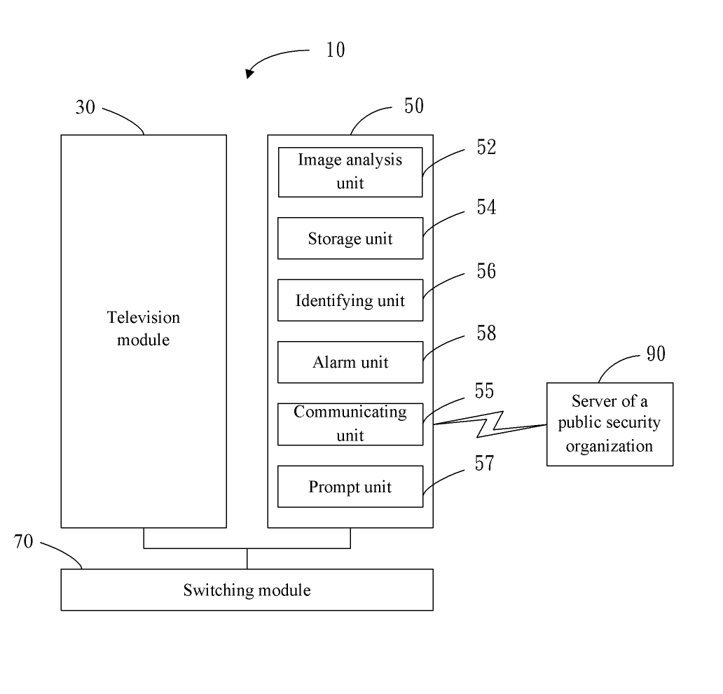

### BACKGROUND

1. Technical Field

The present disclosure relates to televisions, especially relates to a multifunctional television.

2. Description of the Related Art

Televisions have become necessary devices for families. The television mainly provides TV programs, online games, for example. Although many functions are available for televisions, there is still a need to add other functions.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

The drawing is a diagram block of a multifunctional television, according to an exemplary embodiment.

### DETAILED DESCRIPTION

The drawing shows a multifunctional television 10 of an embodiment. The multifunctional television 10 includes a television mode and a monitoring mode. The multifunctional television 10 includes a television module 30 for broadcasting television shows in the television mode, a monitoring module 50 for monitoring in the monitoring mode and a switching module 70 for switching the multifunctional television 10 between the television mode and the monitoring mode. In this embodiment, the switching module 70 includes a button positioned on a housing of the multifunctional television 10 or on a remote controller for the multifunctional television 10.

The television module 30 can be any television module 30 of a television in prior art, the detail blocks of the television module 30 are omitted.

The monitoring module 50 includes an image analysis unit 52, a storage unit 54, an identifying unit 56 and an alarm unit 58. The image analysis unit 52 is used for periodically (e.g. every ten seconds) capturing images of surrounding area of the multifunctional television 10 and comparing a current image with a previous image to determine whether the current image and the previous image are different. In the embodiment, the multifunctional television 10 is placed in a room. When there are no people, the images are substantially the same, and when a person comes into a monitor range of the image analysis unit 52, the image captured by image analysis unit 52 is distinctly different from the image before the person comes into the monitor range. In this embodiment, the image analysis unit 52 includes a camera mounted on a housing of the multifunctional television 10 for capturing the images. The storage unit 54 is used for storing the current image if the current image is different from the previous image. The identifying unit 56 is used for determining whether there is a suspicious character in the current image if the current image and the previous image are different. In this embodiment, the identifying unit 56 controls a display screen of the multifunctional television 10 to display a password input box to receive a password input by a user and compares the input password to a preset password. If the input password is the same as the preset password, the identifying unit 56 determines there is no suspicious character. If the input password is different from the preset password, the identifying unit 56 determines there is a suspicious character. The alarm unit 58 is used for sending a warning signal if there is the suspicious character. In this embodiment, the alarm unit 58 includes a loudspeaker.

In an alternative embodiment, the monitoring module 50 further includes a prompt unit 57. The prompt unit 57 generates a prompt signal, e.g. a voice, to prompt a user to input a password.

In another alternative embodiment, the monitoring module 50 further includes a communicating unit 55. The storage unit 54 stores location information of the multifunctional television 10. The communicating unit 55 connects a server 90 of a public security organization through a network. The communicating unit 55 is used for transmitting the stored location information to the server 90 if there is a suspicious character.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A multifunctional television, wherein the multifunctional television is operable in a television mode and a monitoring mode, the multifunctional television comprising:
a television module for broadcasting television shows in the television mode;
a monitoring module operable in the monitoring mode, the monitoring module comprising:
an image analysis unit for periodically capturing images of surrounding area of the television and comparing a current image with a previous image to determine whether the current image and the previous image are different;
an identifying unit for determining whether there is a suspicious character in the current image if the current image and the previous image are different; and
an alarm unit for sending a warning signal if there is a suspicious character; and
a switching module for switching the multifunctional television between the television mode and the monitoring mode.

2. The multifunctional television as claimed in claim 1, further comprising a storage unit for storing location information of the multifunctional television and the current image if the current image is different from the previous image, wherein the monitoring module further comprises a communicating unit, the communicating unit connects a server of a public security organization through a network, the communicating unit is configured to transmit the stored location information to the server if there is a suspicious character.

3. The multifunctional television as claimed in claim 1, wherein the switching module includes a button positioned on a housing of the multifunctional television.

4. The multifunctional television as claimed in claim 1, wherein the switching module includes a button positioned on a remote controller for the multifunctional television.

5. The multifunctional television as claimed in claim 1, wherein the image analysis unit comprises a camera mounted on a housing of the multifunctional television for capturing the images.

6. The multifunctional television as claimed in claim 1, wherein the identifying unit is configured to control a display screen of the multifunctional television to display a password input box and compare a password input by a user to a preset password, if the input password is same as the preset password, the identifying unit determines there is no suspicious character, if the input password is different from the preset password, the identifying unit determines there is a suspicious character.

7. The multifunctional television as claimed in claim 6, wherein the monitoring module further comprises a prompt unit, the prompt unit configured to generate a prompt signal to prompt a user to input a password.

8. The multifunctional television as claimed in claim 1, wherein the alarm unit includes a loudspeaker.
